(19) United States
(12) Patent Application Publication
(10) Pub. No.: US 2009/0172723 A1
(43) Pub. Date: Jul. 2, 2009

(54) Television advertisement placement more resistant to user skipping

(75) Inventors: Roy Shkedi, New York, NY (US); Davis S. Alavi, Eugene, OR (US)

Correspondence Address: LOUIS J. HOFFMAN, P.C., 11811 North Tatum Boulevard, Suite 2100, Phoenix, AZ, 85028, US

(73) Assignee: AlmondNet, Inc.

(21) Appl. No.: 11/968,107

(22) Filed: Dec. 31, 2007

(51) Int. Cl. H04N 7/025

(52) U.S. Cl. 725/32

(57) ABSTRACT

Television equipment detects viewers' actions in skipping temporally interleaved television advertising content and, in response, automatically causes selected television advertising content to be spatially combined with a temporal portion of the viewed television programming content, e.g., juxtaposed adjacent to or overlaid on the television advertising content. As a result of the spatial combination, skipping such juxtaposed or overlaid advertising content would also cause skipping of the corresponding temporal portion of the viewed programming content. In some implementations, once viewer ad skipping is detected, advertising content can spatially combined with subsequently viewed television programs of the same type, or interleaved advertising content can be automatically removed from the remainder of the television program or from subsequently viewed television programs of the same type. Viewer skipping of interleaved advertising can be explicitly detected by detecting user-selected commands during recognized interleaved advertising, or implicitly detected by analysis of sequences of selected user commands.

### BACKGROUND

The field of the present invention relates to television advertising. In particular, systems and methods are disclosed for delivering advertising content juxtaposed to, or overlaid on, programming content.

Common practices among television viewers include switching channels to skip viewing of TV ads and recording television programs for later viewing. During that later viewing, it is also a common practice for the viewer to skip the advertising content (e.g., by fast-forwarding the commercials). Because advertising is a primary source of revenue supporting the television industry, such skipping of television advertising content concerns television advertisers.

Systems and methods wherein viewers who skip some advertising content can be presented with other advertising content that cannot readily be skipped, while only minimally impacting a viewer's television viewing experience, has been disclosed in U.S. Pat. Pub. No. 2004/0005143 A1 to Tsuru et al. Tsuru discloses a system wherein advertising is spatially combined with television program content upon detection of viewer skipping of temporally interleaved advertising. It may be desirable to provide additional functionality for removing from programming temporally interleaved ads that are skipped, for combining spatial ads with additional television programming, or for detecting ad skipping.

### SUMMARY

Television equipment detects viewers' actions in skipping through temporally interleaved television advertising content and, in response, automatically causes a selected television advertising content to be spatially combined with a temporal portion of the viewed television program, e.g., juxtaposed adjacent to or overlaid on the television advertising content. As a result of the spatial combination, skipping such juxtaposed or overlaid advertising content would also cause skipping of the corresponding temporal portion of the viewed programming content.

In some implementations, once viewer ad skipping is detected, advertising content can spatially combined with subsequently viewed television programs of the same type. In some implementations, once viewer ad skipping is detected, interleaved advertising content can be automatically removed from the remainder of the television program or from subsequently viewed television programs of the same type.

Viewer skipping of interleaved advertising can be (i) explicitly detected by detecting user-selected commands during recognized interleaved advertising, or (ii) implicitly detected by analysis of sequences of selected user commands.

Objects and advantages pertaining to television programming and advertising content may become apparent upon referring to the exemplary embodiments illustrated in the drawings and disclosed in the following written description or claims.

### BRIEF DESCRIPTION OF THE DRAWINGS

FIGS. 1-3 illustrate schematically temporal sequences and screen appearances for television programming and advertising content that are temporally interleaved, spatially juxtaposed, or spatially overlaid, respectively.

FIGS. 4-6 illustrate schematically temporal sequences for television programming and temporally interleaved advertising content that is skipped.

FIGS. 7-9 illustrate schematically temporal sequences for television programming and juxtaposed or overlaid advertising content replacing interleaved advertising content that was skipped.

FIGS. 10 and 11 illustrate schematically a television screen with advertising content overlaid on programming content.

FIGS. 12-14 illustrate schematically a television screen with programming content and juxtaposed advertising content.

FIG. 15 illustrates schematically a temporal sequence for television programming and juxtaposed or overlaid advertising from which interleaved advertising has been removed.

FIGS. 16 and 17 illustrate schematically connections among an ad server, a VOD, IPTV, or SDV server or broadcast content source or server, a DVR or set-top box, and/or a television.

FIGS. 18-20 illustrate schematically temporal sequences of channel switching that can be recognized as ad skipping.

The embodiments shown in the figures are exemplary and should not be construed as limiting the scope of the present disclosure and/or appended claims. In particular, the relative lengths of temporal intervals and the relative sizes and shapes of areas of a television screen are illustrated schematically only, and those relative lengths, shapes, or sizes shall not be limited by the figures.

### DETAILED DESCRIPTION OF EMBODIMENTS

Some of the terms used in the present disclosure or appended claims are defined as follows.

Viewer (also known as a “user” or “subscriber”)—one or more persons receiving television service at a delivery end-point within a household, office, business, or other site or establishment served by a television provider. Thus, delivery of television programming or advertising content to “the viewer” might involve a single person or multiple persons at the delivery end point location. The delivery end-point of the television content may be one television set or multiple sets of a given viewer and may include one or more set-top boxes or DVRs.

Television provider (TVP)—an entity that provides television service to a viewer via any suitable transmission medium, including but not limited to coaxial cable, fiber-optical cable, network cable, phone line, satellite transmission, wireless transmission, or VHF or UHF transmission.

Television (TV)—any device or equipment, including a conventional television screen, a computer screen, or monitor, driven by a television programming source, that is, when suitably configured, connected, or programmed, capable of displaying visually perceptible content provided by a TV provider via any suitable transmission medium, including but not limited to equipment (hardware or software) capable of displaying conventional broadcast or cable television (analog or digital), internet protocol television (IPTV), interactive television, or video on demand (VOD). The displayed content can include video (which often includes an audio portion), Internet web pages, interactive games, TV programs, movies or motion pictures, or multimedia presentations.

Set-top box (STB)—a device that connects a television and a signal source. The STB receives an incoming signal, extracts content from the received signal, and transmits the extracted content to the television to be presented to a viewer. The signal source can be a computer network cable (e.g., an Ethernet or other transmission-speed cable), a satellite dish, a coaxial cable connected to a cable television system, a telephone line or digital subscriber line (DSL), a wireless network connection, an antenna (VHF, UHF, digital, or other), or another suitable signal source. An STB may or may not include a dedicated television tuner. Depending on the signal source, an STB can receive television programming content via any suitable transmission protocol, including but not limited to quadrature amplitude modulation (QAM), IPTV, switched digital video (SDV), or other suitable protocol. In some instances an STB can be programmed; STB programs can include applications, software modules, or clients, such as those that fall with the OCAP (OpenCable Application Platform) or ETV (Enhanced TV) standards. Such programs can be “bound,” i.e., associated with only specific transmitted content, or “unbound,” i.e., not associated with any specific transmitted content. Any suitable STB programming can be employed. Despite its name, an STB need not be physically located on top of a television set literally. Under current technology, STBs often are located physically adjacent to the television set, such as in a media cabinet or the like, but it is not even necessary that the STB be located in proximity to the television. Nor is it necessary that the STB be a box, literally. Rather, an STB might be implemented, for example, as a circuit board, integrated circuit, set of integrated circuits, or software that is physically integrated with another “box,” such as the television, a cable or other connection, a computer, or a building equipment or junction box, which also has other functions, or without being housed in any “box” at all.

Digital video recorder (DVR, alternatively personal video recorder or PVR)—a device that stores video content in a digitally encoded format on a digital storage medium, such as a hard drive, and enables a viewer to play back the stored content. A DVR can comprise a stand-alone unit connected to a television, an STB, or a signal source, the DVR can comprise software that programs a computer to perform DVR storage and playback functions, or the DVR can be implemented using any suitable hardware or software. A DVR can be located at a viewer's location or can be located remotely, e.g., as a network based DVR.

Broadcast television content—television content that is transmitted to multiple viewers simultaneously from a television provider (using any suitable transmission medium or signal source) at a time chosen by the provider without any specific request by any viewer or whether any viewer actually views the content. Broadcast television content can be live or pre-recorded.

Video-on-Demand (VOD)—a system that allows viewers to select and view video content delivered by a television provider from a remote signal source in response to a request from the viewer. Typically, the requested video content can be viewed at a time of the viewer's own choosing and can be paused, rewound, or fast-forwarded as desired by the viewer. A VOD system can “stream” the content (enabling viewing of portions of a requested item of video content while other portions are still being delivered from the signal source), or the VOD system can “download” the content and allow viewing only after a complete item is delivered from the signal source. Some VOD systems allow viewers to select and watch video content over a network as part of an interactive television system. VOD television content differs from broadcast television content, described above, on the basis of whether delivery is responsive to a specific request.

Interactive Television (interactive TV, iTV, idTV, or ITV)—any television system that enables a viewer to interact with content delivered to a television. Interactive television can include, but is not limited to, access to Web sites through TV, electronic mail and online chat, online commerce, or enhanced graphics (relative to standard television offerings).

Internet Protocol Television (IPTV, Internet TV, TV-over-Internet, or Web TV)—a system wherein television content is delivered to viewers using Internet Protocol (IP). For residential users, IPTV is often provided in conjunction with Video on Demand and can also be bundled with Internet services such as Internet access, Voice-over-IP (VoIP), or additional telecommunications services (e.g., mobile voice or mobile data service). IPTV can be supplied (such as by a broadband Internet service provider) using a closed network infrastructure, over the Internet or other publicly accessible computer network, or over a corporate LAN or other business network.

Television programming source (or TV source or program source)—a source of television content, including equipment such as a TV tuner, a set-top box, a digital video recorder, a video-on-demand server, an IPTV server, a switched digital video (SDV) server, a broadcast content source or server, a cable box or connection, or a connection to a remote delivery system.

Behavioral targeting—the delivery of specific advertisements to a viewer, the advertisements being selected on the basis of activity of the viewer, typically recent activity, including but not limited to: online searches conducted by the viewer, content viewed or accessed by the viewer online, television content viewed or accessed by the viewer, online advertisements viewed, clicked on, or otherwise accessed by the viewer, online shopping or purchases made by the viewer, and any other form of previous viewer activity.

Ad Server (AS, also referred to as a Central Ad Server, or CAS)—a computer server that manages delivery of television or online advertisements to television viewers or visitors of online sites. A local ad server can be run by a single publisher to serve ads to viewers of that publisher's television programming or visitors of websites of that publisher's Internet domains. A third-party or remote ad server typically is remotely located and can deliver advertisements of one or more advertisers to viewers of television programming of one or more publishers or to visitors of websites of one or more publishers. The remote ad server acts as a central conduit for delivering advertising content, enabling advertisers and publishers to track the distribution of their television or online advertisements, and to control the rotation and distribution of their advertisements across multiple television systems or channels or across the Internet, from one location. The advertisements can be stored on the CAS for later delivery, transmitted to the CAS and then delivered from the CAS upon receiving an ad request, or delivered from another source in response to an ad request received and routed by the CAS. Examples of third-party ad servers include DoubleClick's DART for Publishers central ad server (also known as DFP) and DoubleClick's DART for Advertisers central ad server (also known as DFA).

Television programming content (also referred to as TV programming, TV program, programming, or programming content)—content viewed on a television that is desired to be viewed for its own sake. Television programming content can include movies, television shows (e.g., comedies, dramas, serials, miniseries, documentaries, reality series, game shows, informational or instructional shows, infomercials, children's programming, adult programming), news programming (live or recorded), sports programming (live or recorded), or other programming.

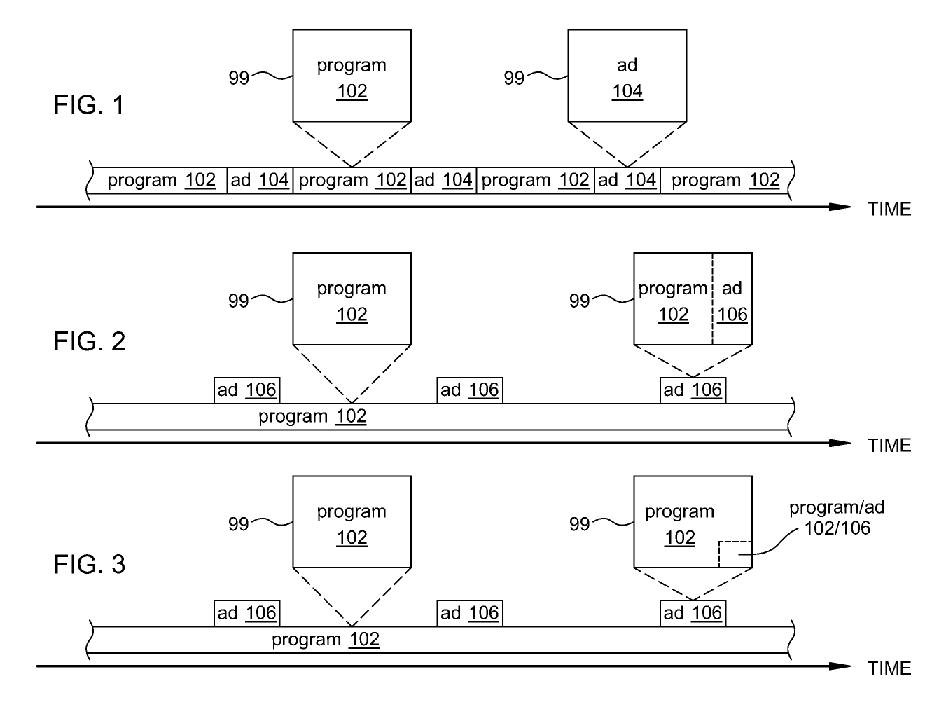

Television advertising content (also referred to as TV advertising, advertisements, ads, commercials, ad content, or advertising)—a full or partial screen video ad, a banner ad, a text ad, an audio ad, or any other form of advertising content suitable for delivery to, and visual or audible presentation by, a television. Television advertising content can be temporally interleaved with television programming content (illustrated schematically in FIG. 1), i.e., programming content 102 is periodically interrupted so that advertising content 104 can be shown during the interruptions; each occupies television screen 99 alone at different times. For example, traditional television commercial spots are temporally interleaved with corresponding programming content. Television advertising content also can be spatially juxtaposed to, spatially overlaid on, or otherwise spatial combined with television programming content (illustrated schematically in FIGS. 2 or 3), e.g., programming content 102 and advertising content 106 are shown simultaneously (at least for a temporal portion of the programming content), on distinct portions of television screen 99 (i.e., juxtaposed, as in FIG. 2) or with the advertising content covering a spatial portion of the programming content (i.e., overlaid, as in FIG. 3).

Skipping—preventing or avoiding the viewing of at least a portion of a television content temporal sequence. Several methods of skipping are discussed in the present disclosure. In a first method, television content can be skipped by moving from one temporal point in the television content sequence to another, non-adjacent temporal point in the content sequence, thereby skipping the television content between the two non-adjacent temporal points. Such skipping can be achieved by fast-forwarding through the skipped content or by moving discontinuously through the television content sequence so that the skipped content is not presented at all, e.g., by moving directly from the origin point to the destination point. Fast-forwarding is generally applicable to recorded television content (whether recorded by the viewer or accessed from a television provider, e.g., using VOD). In another method, a portion of a first television content sequence can be skipped by changing to one or more alternate television content sequences, e.g., by switching TV channels (or by muting or volume reduction or even by switching the television off during the skipped portion of a first television content sequence) and then changing back to the first television content sequence (or un-muting or increasing the volume or switching the television back on), thereby skipping that temporal portion of the first television content sequence being broadcasted or delivered while the television is switched to the alternate content sequence (or while the television is switched off). The second method of skipping is generally applicable to broadcast television content, which may be live television content, but it can also be applicable to recorded television content if the playback does not stop when the channel is changed (or the TV turned off). An example of such skipping is the common practice of changing TV channels during a TV commercial and then switching back to the original channel.

Fast-forwarding—increasing the presentation speed of video or audio content to pass through certain television content more quickly to access subsequent television content sooner. Fast-forwarding is often employed by television viewers to move quickly through interleaved advertising to arrive sooner at subsequent programming content (sometimes colloquially referenced, e.g., as “fast-forwarding through the commercials”). Fast-forwarding is generally applicable to recorded television content available via a DVR, network based DVR, VOD, VCR, a TV or IPTV, a network source, or other recorded programming sources.

Spatially combining—spatially juxtaposing, spatially overlaying, or otherwise spatially combining one television content with another on the same screen so they are viewable simultaneously. Skipping one of the spatially combined contents typically results in skipping of the other as well.

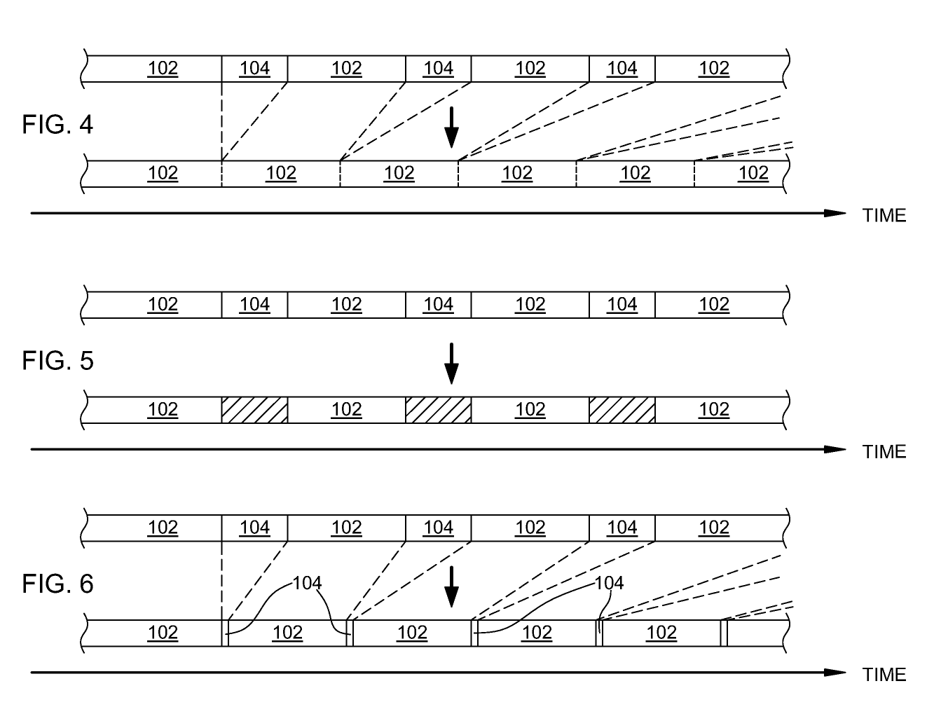

The upper portions of FIGS. 4-6 illustrate schematically a temporal content sequence comprising television programming content 102 with temporally interleaved television advertising content 104. The content sequence could represent, e.g., a television program 102 periodically interrupted by traditional television commercial spots 104.

If the content sequence or portions thereof can be skipped, a viewer can skip the interleaved advertising content 104, e.g., by discontinuously moving to a further point in the content sequence (as in the lower portion of FIG. 4); by switching channels or switching the television off (as in the lower portion of FIG. 5); or by fast-forwarding (as in the lower portion of FIG. 6).

Although FIGS. 4-6 illustrate the viewer skipping all of the advertising content, it may be the case that the viewer may skip only some of the interleaved advertising content 104 and view other parts of the interleaved advertising content 104 at normal speed.

Skipped interleaved advertising content 104 represents a lost opportunity for the respective advertisers or lost revenues for the ad space owners if advertisers pay only for watched ads.

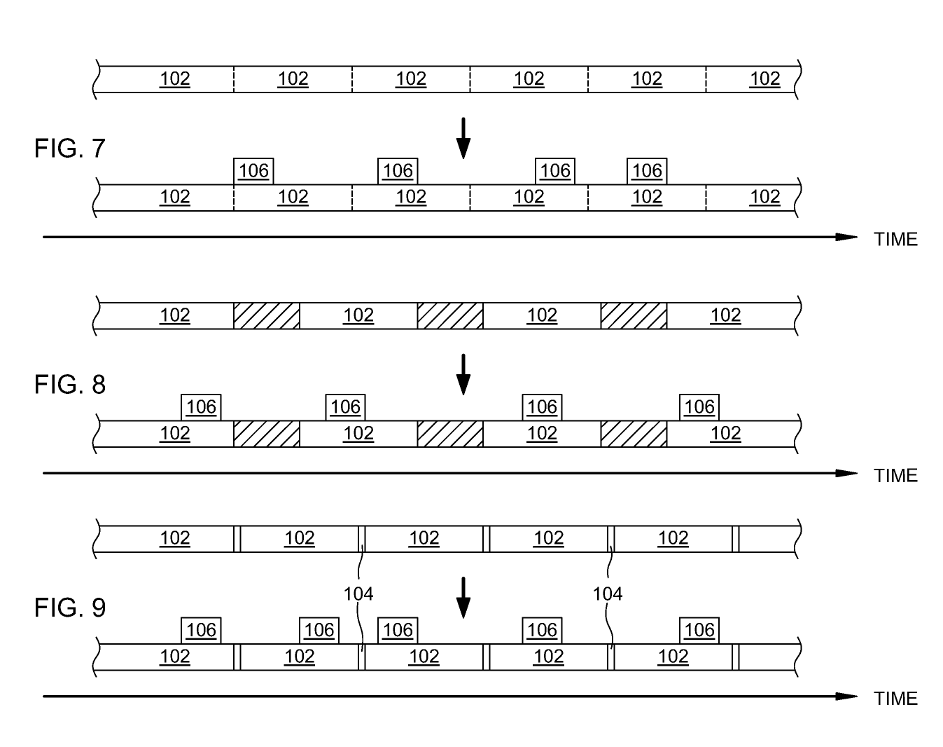

FIGS. 7-9 (corresponding to FIGS. 4-6, respectively) illustrate schematically a method of detecting viewers skipping television advertising content 104 that is temporally interleaved with viewed television programming content 102, and in response to that detection, automatically causing a temporal portion of the viewed television programming content 102 to be spatially combined (e.g., juxtaposed or overlaid on) with television advertising content 106 so that skipping the spatially combined advertising content 106 also would result in skipping the corresponding temporal portion of the viewed programming content 102.

Because a viewer typically does not wish to miss a portion of the programming content 102, it is likely that the viewer will also view the spatially combined advertising content 106. In this way the advertising opportunity lost when the viewer skips a temporally interleaved advertisement 104 can be at least partly recovered by showing the spatially combined advertisement 106.

The advertising content 106 can be of any type suitable for presentation by a television, including but not limited to video, audio, images, graphics, or text.

Skipping of temporally interleaved advertising content can be detected automatically in any suitable way, including but not limited to examples set forth herein. Such skipping typically is accomplished by a television viewer sending a signal or command to a television source. Such a command or signal can be initiated using, e.g., a remote control device or an on-screen menu.

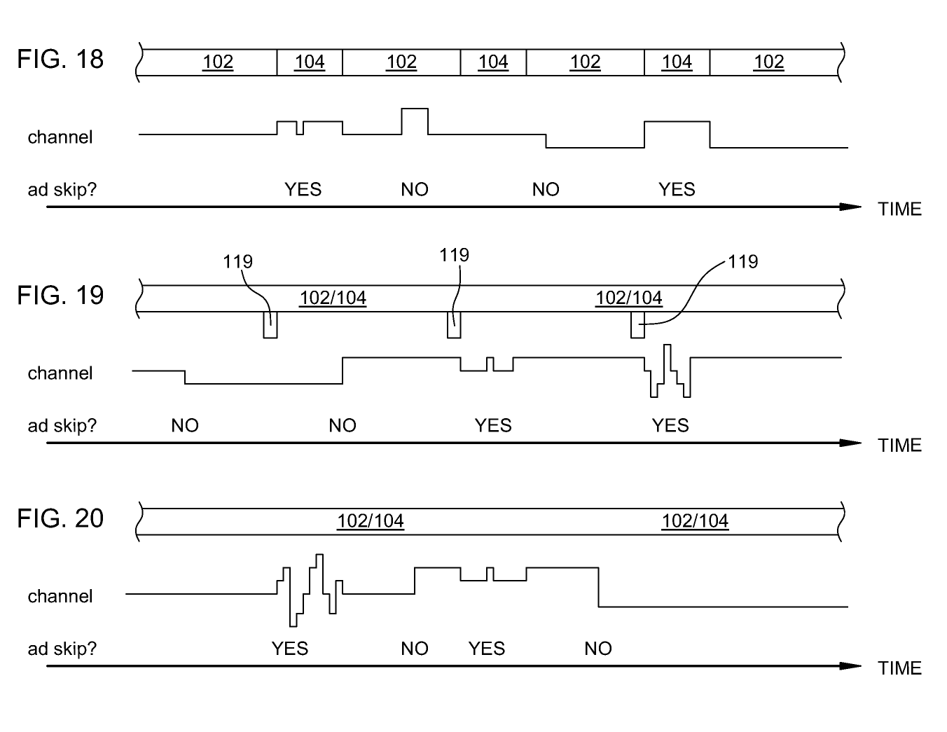

In one exemplary implementation, the interleaved advertising content typically is distinguishable from the television program (as in FIG. 18), e.g., by inclusion of a flag 119, cue, or other marker indicating the presence of the interleaved advertising content (as in FIG. 19), by presentation of interleaved advertising content during known, prescheduled intervals, or by other means. A “skip,” “fast-forward,” “switch off,” “mute” or “reduce volume,” or “change channel” signal or command, if initiated and detected when recognized interleaved advertising content is being shown, can be used to explicitly detect ad skipping so as to trigger spatial combination of advertising content with the programming content. Any suitable hardware, software, or combination (e.g., in the viewer's STB or television or DVR, in a cable or IPTV transmission system or headend, in a remote server, or in some other suitable location or combination of locations) can be employed to determine whether the initiated command occurred during recognized interleaved advertising content or not. For example, a suitable software module, client, or application can be loaded onto the viewer's STB for automatically detecting a viewer skipping interleaved advertising content, including but not limited to an OCAP application (suitable for, inter alia, newer STB's) or an ETV application (suitable for, inter alia, legacy STB's). Such applications can be resident in the STB or can be loaded into the STB when needed or desired from a remote server or from a cable or IPTV transmission system. An STB application can merely report viewer commands to a server or transmission system with the determination of viewer skipping of interleaved advertising performed remotely, or the determination can be performed locally by the STB.

In another exemplary implementation, distinguishing the interleaved advertising content from the programming content is not necessary. Instead, detection and analysis of a temporal sequence of “switch off,” “mute” or “change volume,” or “change channel” commands can be employed to detect implicitly that the viewer has skipped temporally interleaved advertising content (as in FIG. 20). For example, certain patterns of channel switching, e.g., remaining on a first channel for 10-15 minutes, switching to one or more other channels for 1-2 minutes, switching back to the first channel for another 10-15 minutes, and so on, may suggest that the viewer is switching to other channels during interleaved ads shown during a program on the first channel. In another example, in a system wherein spatial advertising is combined only during television program segments, channel switching during time intervals lacking spatial advertising can indicate viewer skipping of interleaved advertising. Any suitable pattern-analysis algorithm or criterion can be employed to infer that a viewer has skipped interleaved advertising content. Any suitable hardware, software, or combination (including those recited or described in the preceding paragraph) can be employed for detecting and analyzing a temporal sequence of commands to determine that a viewer has skipped interleaved advertising content.

In another example, channel switching by a viewer can be detected and analyzed. For example, a channel switch away from and then back to a first television channel can be an indication of an interleaved ad being skipped (assuming the first channel was watched for longer than a typical advertising break). A determination that an interleaved ad was skipped can be based on, e.g., one or two returns to the first channel within 120 seconds of leaving. The threshold number of switches from/to the first channel or the length of the time interval during which those channel switches are counted can depend on the average interleaved ad break length or on the “sensitivity” of the television broadcaster or advertisers to ad skipping. A less aggressive policy might only combine spatial ads after three switches to/from the first channel within a one-minute interval, while a more aggressive policy might combine spatial ads after only a single return to a channel within two minutes of leaving. Any suitable threshold or time interval can be employed.

In another example, muting or volume changes by a viewer can be detected and analyzed. A “mute” or “reduce volume” command followed by an “un-mute” or “increase volume” command within one or two minutes (with or without accompanying channel changes) can be an indication that an interleaved ad is being skipped (or at least not heard). Advertising can be spatially combined with the television program in response to such a sequence of commands. Because spatially combined advertising typically would not include an audio portion (to avoid interfering with the audio portion of the television program), the spatially combined ad could not be skipped by muting or other volume changing commands. If the spatially combined ad does include an audio portion, skipping that audio portion by muting or volume reduction would also result in skipping the audio portion of the television program.

Once it is determined that a viewer has skipped temporally interleaved advertising content, the advertising content to be spatially combined with the programming content can be delivered in any suitable way using any suitable software, hardware, or combination.

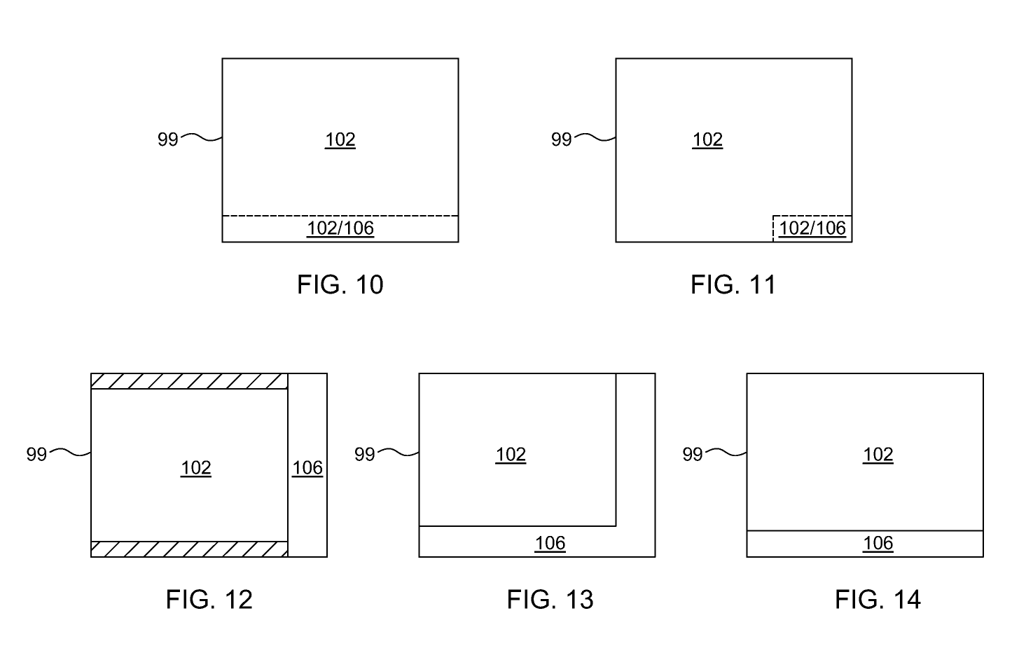

Overlaid advertising content 106 can be positioned anywhere on television screen 99, but in a preferred embodiment, it can be positioned along one or more of a top, bottom, or side edge of the screen (e.g., along the bottom edge as in FIG. 10) or in one or more of the corners of the screen (e.g., in the bottom, right-hand corner as in FIG. 11).

If it is overlaid, advertising content 106 can completely obscure the underlying spatial portion of programming content 102 or can be partly transparent to allow the underlying programming content to at least partly show through. Thus, FIGS. 10-11 use numerals 102/106, indicating that the strip (FIG. 10) or region (FIG. 11) can be a spatial combination of programming content 102 and advertising content 106, either with both visible or with advertising content 106 obscuring programming content 102.

If it is juxtaposed, advertising content 106 can be positioned anywhere on television screen 99, but in a preferred embodiment, it can be positioned along one or more of a top, bottom, or side edge of the screen (e.g., along the right edge as in FIG. 12, along both bottom and right edges as in FIG. 13, or along the bottom edge as in FIG. 14) or in one or more of the corners of the screen (not shown).

Depending on the size and position of juxtaposed advertising content 106 and the size and shape of television screen 99, it might be necessary or desirable to resize programming content 102 suitably to allow it to fit into the remaining portion of television screen 99. Such resizing can be done in a manner that preserves the spatial aspect ratio of the programming content 102 (e.g., as in FIGS. 12 and 13, wherein the programming content 102 is shown compressed in both horizontal and vertical dimensions to preserve its spatial aspect ratio), or the aspect ratio can be changed (e.g., as in FIG. 14, wherein the programming content 102 is shown compressed in only the vertical dimension thereby altering its spatial aspect ratio). In an embodiment wherein the programming content 102 is compressed in both dimensions to accommodate juxtaposed advertising content 106, areas of the television screen 99 can be left blank (as in FIG. 12) or the juxtaposed advertising content can fill the entire screen area not filled by programming content 102 (as in FIG. 13).

In one example of interest presently, if programming content 102 is presented in a 4:3 aspect ratio on a television having a 16:9 aspect ratio, then it is common to have a pair of solid strips at the left and right sides of the television, which can be used for presenting juxtaposed advertising content 106.

Spatially combined advertising content can be present during an entire TV program. More typically, as illustrated schematically in FIGS. 2, 3, and 7-9, advertising content 106 is spatially combined with programming content 102 so that the ads are displayed during only selected segments of the viewed programming content. In that typical example, advertising content 106 is displayed during limited, perhaps periodically occurring, time intervals arrayed temporally across the programming content (e.g., one minute every fifteen minutes; any other suitable durations or intervals can be employed).

It may be desirable in some instances to display the spatially combined advertising content during such intervals that substantially correspond to the durations and time intervals of the temporally interleaved advertising content (had it not been skipped).

It may be desirable in some instances to display the advertising content during specific thematically related portions of the programming content. For example, if advertising for an airline is displayed, that content can be spatially combined during a scene of a television program depicting air travel. A vast number of other, similar pairings can be made (e.g., a baseball game can be telecast with spatially combined advertising for baseball tickets; a camping scene in an outdoor documentary can be spatially combined with advertising for sleeping bags and tents; a scene from a television drama depicting a wedding and honeymoon can be spatially combined with advertising for a vacation resort).

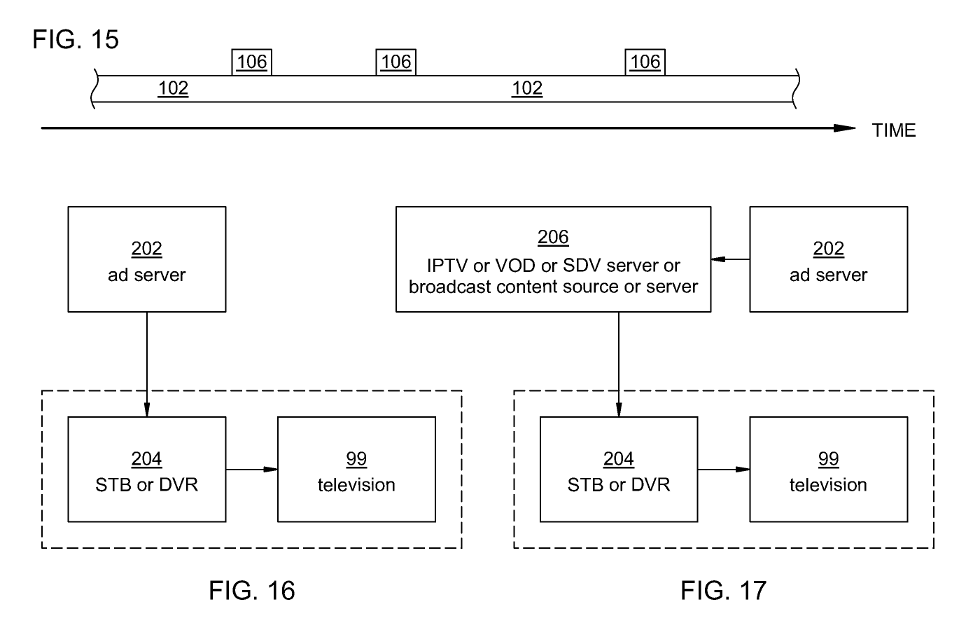

The ordinary, temporally interleaved advertising content 104 can be left in place when advertising content 106 is spatially combined with programming content 102. Alternatively, skipped interleaved advertising content 104 can be removed from recorded programming content 102 (as in FIG. 15; whether recorded by the viewer or supplied by a television provider or broadcaster), thereby eliminating the viewer's need to skip subsequent portions of interleaved advertising content 104. Although temporally interleaved advertising content can be similarly removed from live programming content, there is typically no advantage in doing so. In some implementations the programming content, interleaved advertising content, and/or spatially combined advertising content are transmitted as separate streams or channels that are combined for presentation on the viewer's television. In that case, the interleaved advertising content can be omitted from the combination when it has been determined that the viewer is skipping it, or the spatially combined advertising content can be omitted from the combination if that determination has not been made.

All or portions of the interleaved advertising content in the remainder of a given television program can be removed in response to the viewer skipping a portion of the interleaved advertising earlier in the television program. In one variation, all temporally interleaved advertising can be removed from the remainder of the program. In another variation, temporally interleaved advertising can be removed from only the next one or more succeeding ad breaks after skipping is detected, with interleaved advertising presented again after those ad breaks (at least until skipping is detected again). Interleaved advertising can be removed from any suitable or desirable number of succeeding ad breaks. In another variation, only later portions of interleaved ads in a given commercial break can be removed in response to skipping at the beginning of that break.

Even if temporally interleaved advertising content 104 is removed from an entire television program, similar temporally interleaved advertising content can still be included in other programs or on other channels.

The temporally interleaved advertising content can be removed by television 99 or by any other TV source. Any suitable hardware or software can be employed for removing interleaved advertising content 104 from programming content 102 (e.g., in the viewer's STB, television, or local DVR, in a network DVR, in a cable or IPTV transmission system or headend, in a remote server, or in some other suitable location or combination of locations).

The removal of temporally interleaved advertising content can occur in real time, i.e., as the programming content is viewed, or before viewing of the programming content. Recognition of interleaved advertising to be removed can be explicit or implicit. In one example of implicit recognition, the interleaved advertising content can be identified by detecting the typical increase in audio volume during television commercials, and removal of interleaved advertising content is achieved by removal of content accompanied by such increased audio volume. Detection and removal of temporally interleaved advertising (explicitly or implicitly) can be achieved by any suitable implementation of hardware or software (including those disclosed above).

Once a viewer skips temporally interleaved television advertising content during a particular type of television program, that type of television program can be noted and advertising content can be spatially combined automatically with television programs of the same type when the same viewer views such programming content later.

In one example, if the viewer skips interleaved advertising in one episode of a given television series, then advertising content can be spatially combined automatically with future episodes of that series.

In another example, if a viewer skips interleaved advertising during a televised basketball game, then advertising content can be spatially combined automatically with future basketball telecasts.

In a third example, if a viewer skips interleaved advertising during a particular news broadcast, then advertising content can be spatially combined automatically with future news broadcasts.

Any suitable hardware or software can be employed for spatially combining subsequently viewed programming content with advertising content.

Likewise, if a viewer skips temporally interleaved television advertising content during a particular type of programming content, the same type of advertising content can be noted and interleaved advertising content of the same type can be removed automatically from subsequently viewed programming content of any type.

Any suitable hardware or software can be employed for removing similar interleaved advertising content from subsequently viewed programming content (including those disclosed above).

Ad server 202 is typically used to deliver advertising content to be spatially combined with programming content. The advertising content can be delivered from ad server 202 to any television source, such as directly to a viewer's television 99, directly to a viewer's DVR or set-top box 204 (as in FIG. 16), or to a VOD server, an IPTV server, an SDV server, or a broadcast content source or server 206 and thence to television 99 or DVR or set-top box 204 (FIG. 17).

Advertising content for spatial combining can be delivered to set-top box 204 at any time, and if delivered in advance, stored on set-top box 204 or a DVR, or on VOD or IPTV server 206, until spatially combined with subsequently viewed programming content. It can sometimes happen that such pre-delivered ads might not be spatially combined with a television program, e.g., if no interleaved ad skipping is detected. One example of advanced delivery of ads for spatial combining can be implemented to utilize time periods of readily available bandwidth (i.e., so-called “dead hours” when fewer viewers are watching television). Such pre-delivered ads may or may not be intended to be spatially combined with a particular television program. Another example of advanced delivery of ads for spatial combining can be implemented when a viewer records a television program on a DVR for later viewing.

The programming content and the advertising content can be spatially combined by any TV source, including television 99, set-top box or DVR 204, or VOD server, IPTV server, SDV server, or broadcast content source or server 206. Any suitable hardware or software can be employed for spatially combining advertising content with programming content.

The advertising content can be provided for spatial combination with programming content by the same advertiser whose temporally interleaved advertising content was skipped. In that case the advertiser can at least partly regain the advertising opportunity that was lost when the viewer skipped the advertiser's original interleaved advertising content.

Alternatively, a different advertiser can provide the spatially combined advertising content. Flow of advertising revenue can be altered as a result of the viewer skipping temporally interleaved advertising content and substitute advertising content being spatially combined with the programming content.

In one example, an advertiser might pay or be debited, or a programming provider might collect or be credited, different advertising revenue amounts for spatially combined advertising versus temporally interleaved advertising that is viewed (i.e., not skipped).

In one example, advertisers may be willing to pay less for spatially combined advertising than for temporally interleaved advertising, because the viewer's attention is not divided in the case of interleaved advertising. If that is the case, the commercial model described here allows for such variable pricing.

In another example, an advertiser whose temporally interleaved advertising content was skipped (i.e., not viewed or viewed only while fast forwarded) might receive a credit or payment refund from the interleaved ad space seller or receive compensation via spatially combined advertising.

Any other suitable revenue distribution arrangement can be implemented using any suitable hardware or software, including preferably computerized database systems keeping track of the credits and debits.

The specific advertising content to be combined with the programming content can be selected in any suitable way. In one example, the selected advertising can be substantially similar in content to the interleaved advertising that was skipped, with the selected advertising being presumably, but not necessarily, provided by the same advertiser.

Alternatively, the selected advertising can differ from the interleaved advertising, and may not be related to it in any way (except that they both are presented along with the same programming). If different, the specific advertising can be selected in a variety of ways. Any suitable method for selecting advertising can be employed and can be implemented using any suitable hardware or software.

In one example, the advertising can be selected in much the same way as traditional television advertising, based on generalized demographics of the expected audience for particular programming content, e.g., advertisements for beer and pickup trucks presented along with professional wrestling, or advertisements for clothing and cosmetics during a romantic comedy.

In another example, the advertising can be more specifically targeted in any suitable way based on observed viewing behavior of the viewer.

In another example, the advertising can accompany the appearance of a product in a scene of a television episode, such as an ad for the corresponding product can appear precisely when a soda or snack food item is being consumed by characters of a sitcom. In that example, the advertising can be timed to appear at the same time the product appears in the programming by direct analysis of video or audio content of the programming or by reading embedded tags or recorded time stamps.

In another example, metadata or tags, e.g., keywords, search terms, category codes, or time stamps, associated with the programming can be employed to select the advertising dynamically.

In another example, viewing behavior can be analyzed to select the advertising, e.g., the frequency of viewers skipping the interleaved advertising can indicate preferences for viewing, or preferential susceptibility to, some types of advertising content versus other types.

In another example, the television advertisements can be selected based on a viewer's online activities or behavior using behavioral targeting techniques, e.g., as disclosed in U.S. application Ser. No. 11/736,544 filed Apr. 17, 2007, which is hereby incorporated into this specification in its entirety by reference.

The spatially combined advertising content can be made interactive. In that case, in response to an indication by the viewer, e.g., using a remote control, the programming content can be interrupted or paused and additional advertising or additional programming content presented that is related to the spatially combined advertising content. For example, a full-screen or full-length version of the advertising can be shown, when the viewer provides such indication, or other related advertising content can be shown. The interactivity can include links to the Internet or to electronic commerce opportunities, or can include delivery, at the viewer's request, of the viewer's phone number, email address, postal address, preferred times to be contacted, or other contact information to the advertiser whose ad was viewed by the viewer or to an entity operating on behalf of the advertiser.

When the viewer finishes interacting with the additional advertising or additional programming content, as indicated by a further signal from the viewer (such as through a remote control device), or when the additional advertising or additional programming content finishes being displayed, viewing of the programming content can be resumed at the interruption point.

Such an interruption during viewing of live or currently broadcasted programming content would require recording and delayed playback so as not to omit programming content that occurred while the additional advertising or additional programming content was viewed; however, technology is available on commercially available STB devices to pause or “rewind” live or currently broadcasted shows (e.g., using DVR functionality provided with many STBs, particularly newer STBs). Alternatively, if the programming content is delivered from a VOD server or network-based DVR, the programming content can also be played after the interruption from the point of the interruption.

Instead of interrupting the programming, the spatially combined advertising content can be marked (i.e., tagged, logged, flagged, or otherwise indicated or identified) or saved by the viewer for later viewing. Any suitable hardware, software, or combination (including those recited or described above) can be employed for providing interactivity or for displaying such additional advertising or additional programming content. At the end of the viewed programming content, the viewer can be given the option to view the additional advertising or the additional programming content that he or she saved or marked, or the viewer can access such saved or marked content at any desired later time in any manner similar to that employed for viewing other content (e.g., via an electronic program guide or VOD menu). In a first example, the additional content is saved on the hard disk of the local DVR and pulled from the DVR for viewing when requested by the user. In a second example, the additional content can be located on a central VOD server or other central server (accessed via IPTV, via the Internet, or via other suitable communication protocols) and, upon request by the viewer, the additional content can be pulled in real-time. In a third example, a code indicating the additional content can be saved (e.g., by the viewer's STB), and, upon request by the viewer, the stored code can be used to designate additional content to be pulled from a corresponding dedicated channel (e.g., a dedicated ad channel or a dedicated programming channel). In the latter two examples a programmer of the corresponding channel or the entity responsible for delivery of the advertising content (whether interleaved or spatial) can control or prevent later viewer access to the additional content, if needed or desired (e.g., upon termination of the relevant ad campaign).

Instead of marking the spatially combined advertising content for later viewing to avoid interrupting the television content, additional information related to the spatially combined advertising content can be presented in the same screen space where the spatially combined advertising was shown by methods similar to those used to present the spatially combined ad in the first place.

An apparatus can comprise at least one programmable electronic processor programmed and connected to perform any of the methods disclosed herein. A single processor or multiple processors can be employed. The processor(s) can be located in any one or more pieces of equipment connected to the television transmission system, including but not limited to a television, a set-top box, a DVR or PVR (local or remote), a programming server, an advertising server, a VOD server, an IPTV server, a SDV server, a broadcast content source or server, a television transmission system headend, or other equipment.

An apparatus can comprise at least one storage medium encoded with programming instructions for performing any of the methods disclosed herein. Programming instructions can be hard-wired into one or more processors located in equipment connected to the television transmission system, or programming instructions can be implemented in temporary or permanent storage or in replaceable media, such as by including programming in microcode, object-oriented code, web-based or distributed software modules that operate together, RAM, ROM, CD-ROM, DVD-ROM, hard drives, thumb drives, flash memory, optical media, magnetic media, semiconductor media, or any future storage alternatives.

It is intended that equivalents of the disclosed exemplary embodiments and methods shall fall within the scope of the present disclosure and/or appended claims. It is intended that the disclosed exemplary embodiments and methods, and equivalents thereof, may be modified while remaining within the scope of the present disclosure or appended claims.

For purposes of the present disclosure and appended claims, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless: (i) it is explicitly stated otherwise, e.g., by use of “either . . . or,” “only one of . . . ,” or similar language; or (ii) two or more of the listed alternatives are mutually exclusive within the particular context, in which case “or” would encompass only those combinations involving non-mutually exclusive alternatives. For purposes of the present disclosure or appended claims, the words “comprising,” “including,” and “having” shall be construed as open-ended terminology, with the same meaning as if the phrase “at least” were appended after each instance thereof.

What is claimed is:

1. A method comprising, in response to automatic detection of a viewer skipping television advertising content that is temporally interleaved with segments of a television program:
(a) automatically causing selected television advertising content to be spatially combined with at least one later-viewed television program segment so that skipping the spatially combined television advertising content also causes skipping of the corresponding later-viewed television program segment;
(b) noting the type of the television program during which skipping of the interleaved advertising content is detected; and
(c) automatically causing selected advertising content to be spatially combined with at least one segment of a subsequently viewed television program of the same type.

2. The method of claim 1 further comprising automatically removing the interleaved advertising content from the subsequently viewed television program.

3. The method of claim 1 further comprising automatically detecting the viewer skipping the interleaved advertising content by (i) analyzing a temporal sequence of “change channel,” “mute” or “change volume,” or “switch off” commands transmitted by the viewer during a time period during which at least a portion of the programming content and interleaved advertising content are being displayed and (ii) recognizing the analyzed sequence as indicative of the viewer skipping the interleaved advertising content.

4. The method of claim 1 further comprising automatically detecting the viewer skipping the interleaved advertising content by detecting a “fast-forward,” “skip,” “change channel,” “mute” or “change volume,” or “switch off” command during the interleaved advertising content.

5. The method of claim 1 wherein the spatially combined advertising content is delivered from an ad server before a viewer begins viewing the television program and is stored on equipment associated with a television programming source.

6. The method of claim 1 wherein the spatially combined advertising content and the interleaved advertising content are provided by different advertisers.

7. The method of claim 1 wherein the spatially combined advertising content is selected based on (i) the viewed television program, (ii) observed viewing behavior associated with a viewer, or (iii) observed online behavior associated with a viewer.

8. The method of claim 1 wherein the later-viewed television program segment and the spatially combined advertising content are spatially combined by a TV programming source.

9. The method of claim 1 further comprising:
in response to an indication received from a viewer of the spatially combined advertising content, interrupting the later-viewed television program segment and presenting additional advertising content that is related to the spatially combined advertising content; and
thereafter, resuming the later-viewed television program segment.

10. A system comprising at least one computer structured and connected to:
(a) automatically cause, in response to automatic detection of a viewer skipping television advertising content that is temporally interleaved with segments of a television program, selected television advertising content to be spatially combined with at least one later-viewed television program segment so that skipping the spatially combined television advertising content also causes skipping of the corresponding later-viewed television program segment;
(b) note the type of the television program during which skipping of the interleaved advertising content is detected; and
(c) automatically cause selected advertising content to be spatially combined with at least one segment of a subsequently viewed television program of the same type.

11. The system of claim 10 further comprising at least one computer structured and connected to remove automatically the interleaved advertising content from the subsequently viewed television program.

12. The system of claim 10 further comprising at least one computer structured and connected to detect automatically the viewer skipping the interleaved advertising content by (i) analyzing a temporal sequence of “change channel,” “mute” or “change volume,” or “switch off” commands transmitted by the viewer during a time period during which at least a portion of the programming content and interleaved advertising content are being displayed and (ii) recognizing the analyzed sequence as indicative of the viewer skipping the interleaved advertising content.

13. The system of claim 10 further comprising at least one computer structured and connected to detect automatically the viewer skipping the interleaved advertising content by detecting a “fast-forward,” “skip,” “change channel,” “mute” or “change volume,” or “switch off” command during the interleaved advertising content.

14. The system of claim 10 wherein the spatially combined advertising content is delivered from an ad server before a viewer begins viewing the television program and is stored on equipment associated with a television programming source.

15. The system of claim 10 wherein the spatially combined advertising content and the interleaved advertising content are provided by different advertisers.

16. The system of claim 10 wherein the spatially combined advertising content is selected based on (i) the viewed television program, (ii) observed viewing behavior associated with a viewer, or (iii) observed online behavior associated with a viewer.

17. The system of claim 10 wherein the later-viewed television program segment and the spatially combined advertising content are spatially combined by a TV programming source.

18. The system of claim 10 further comprising at least one computer structured and connected to:
interrupt, in response to an indication received from a viewer of the spatially combined advertising content, the later-viewed television program segment and presenting additional advertising content that is related to the spatially combined advertising content; and
resume thereafter the later-viewed television program segment.

19. An article comprising a tangible medium encoding computer-readable instructions that, when applied to a least one computer, instruct the at least one computer to:
(a) automatically cause, in response to automatic detection of a viewer skipping television advertising content that is temporally interleaved with segments of a television program, selected television advertising content to be spatially combined with at least one later-viewed television program segment so that skipping the spatially combined television advertising content also causes skipping of the corresponding later-viewed television program segment;
(b) note the type of the television program during which skipping of the interleaved advertising content is detected; and
(c) automatically cause selected advertising content to be spatially combined with at least one segment of a subsequently viewed television program of the same type.

20. The article of claim 19 wherein the medium further encodes computer readable instructions that, when applied to at least one computer, instruct the at least one computer to remove automatically the interleaved advertising content from the subsequently viewed television program.

21. The article of claim 19 wherein the medium further encodes computer readable instructions that, when applied to at least one computer, instruct the at least one computer to detect automatically the viewer skipping the interleaved advertising content by (i) analyzing a temporal sequence of “change channel,” “mute” or “change volume,” or “switch off” commands transmitted by the viewer during a time period during which at least a portion of the programming content and interleaved advertising content are being displayed and (ii) recognizing the analyzed sequence as indicative of the viewer skipping the interleaved advertising content.

22. The article of claim 19 wherein the medium further encodes computer readable instructions that, when applied to at least one computer, instruct the at least one computer to detect automatically the viewer skipping the interleaved advertising content by detecting a “fast-forward,” “skip,” “change channel,” “mute” or “change volume,” or “switch off” command during the interleaved advertising content.

23. The article of claim 19 wherein the spatially combined advertising content is delivered from an ad server before a viewer begins viewing the television program and is stored on equipment associated with a television programming source.

24. The article of claim 19 wherein the spatially combined advertising content and the interleaved advertising content are provided by different advertisers.

25. The article of claim 19 wherein the spatially combined advertising content is selected based on (i) the viewed television program, (ii) observed viewing behavior associated with a viewer, or (iii) observed online behavior associated with a viewer.

26. The article of claim 19 wherein the later-viewed television program segment and the spatially combined advertising content are spatially combined by a TV programming source.

27. The article of claim 19 wherein the medium further encodes computer readable instructions that, when applied to at least one computer, instruct the at least one computer to:
interrupt, in response to an indication received from a viewer of the spatially combined advertising content, the later-viewed television program segment and presenting additional advertising content that is related to the spatially combined advertising content; and
resume thereafter the later-viewed television program segment.

28. A method comprising, in response to automatic detection of a viewer skipping television advertising content that is temporally interleaved with segments of a television program:
(a) automatically causing selected television advertising content to be spatially combined with at least one later-viewed television program segment so that skipping the spatially combined television advertising content also causes skipping the corresponding later-viewed television program segment; and
(b) automatically removing subsequent interleaved advertising content from the remainder of the television program.

29. The method of claim 28 further comprising automatically detecting the viewer skipping the interleaved advertising content by (i) analyzing a temporal sequence of “change channel,” “mute” or “change volume,” or “switch off” commands transmitted by the viewer during a time period in which at least a portion of the programming content and interleaved advertising content are being displayed and (ii) recognizing the analyzed sequence as indicative of the viewer skipping the interleaved advertising content.

30. The method of claim 28 further comprising automatically detecting the viewer skipping the interleaved advertising content by detecting a “fast-forward,” “skip,” “change channel,” “mute” or “change volume,” or “switch off” command during the interleaved advertising content.

31. The method of claim 28 wherein the spatially combined advertising content is delivered from an ad server before a viewer begins viewing the television program and is stored on equipment associated with a television programming source.

32. The method of claim 28 wherein the spatially combined advertising content and the interleaved advertising content are provided by different advertisers.

33. The method of claim 28 wherein the spatially combined advertising content is selected based on (i) the viewed television program, (ii) observed viewing behavior associated with a viewer, or (iii) observed online behavior associated with a viewer.

34. The method of claim 28 wherein the later-viewed television program segment and the spatially combined advertising content are spatially combined by a TV programming source.

35. The method of claim 28 further comprising:
in response to an indication received from a viewer of the spatially combined advertising content, interrupting the later-viewed television program segment and presenting additional advertising content that is related to the spatially combined advertising content; and
thereafter, resuming the later-viewed television program segment.

36. A system comprising at least one computer structured and connected to:
(a) automatically cause, in response to automatic detection of a viewer skipping television advertising content that is temporally interleaved with segments of a television program, selected television advertising content to be spatially combined with at least one later-viewed television program segment so that skipping the spatially combined television advertising content also causes skipping the corresponding later-viewed television program segment; and
(b) automatically remove subsequent interleaved advertising content from the remainder of the television program.

37. The system of claim 36 further comprising at least one computer structured and connected to detect automatically the viewer skipping the interleaved advertising content by (i) analyzing a temporal sequence of “change channel,” “mute” or “change volume,” or “switch off” commands transmitted by the viewer during a time period in which at least a portion of the programming content and interleaved advertising content are being displayed and (ii) recognizing the analyzed sequence as indicative of the viewer skipping the interleaved advertising content.

38. The system of claim 36 further comprising at least one computer structured and connected to detect automatically the viewer skipping the interleaved advertising content by detecting a “fast-forward,” “skip,” “change channel,” “mute” or “change volume,” or “switch off” command during the interleaved advertising content.

39. The system of claim 36 wherein the spatially combined advertising content is delivered from an ad server before a viewer begins viewing the television program and is stored on equipment associated with a television programming source.

40. The system of claim 36 wherein the spatially combined advertising content and the interleaved advertising content are provided by different advertisers.

41. The system of claim 36 wherein the spatially combined advertising content is selected based on (i) the viewed television program, (ii) observed viewing behavior associated with a viewer, or (iii) observed online behavior associated with a viewer.

42. The system of claim 36 wherein the later-viewed television program segment and the spatially combined advertising content are spatially combined by a TV programming source.

43. The system of claim 36 further comprising at least one computer structured and connected to:
interrupt, in response to an indication received from a viewer of the spatially combined advertising content, the later-viewed television program segment and presenting additional advertising content that is related to the spatially combined advertising content; and
resume thereafter the later-viewed television program segment.

44. An article comprising a tangible medium encoding computer-readable instructions that, when applied to a least one computer, instruct the at least one computer to:
(a) automatically cause, in response to automatic detection of a viewer skipping television advertising content that is temporally interleaved with segments of a television program, selected television advertising content to be spatially combined with at least one later-viewed television program segment so that skipping the spatially combined television advertising content also causes skipping the corresponding later-viewed television program segment; and
(b) automatically remove subsequent interleaved advertising content from the remainder of the television program.

45. The article of claim 44 wherein the medium further encodes computer readable instructions that, when applied to at least one computer, instruct the at least one computer to detect automatically the viewer skipping the interleaved advertising content by (i) analyzing a temporal sequence of “change channel,” “mute” or “change volume,” or “switch off” commands transmitted by the viewer during a time period in which at least a portion of the programming content and interleaved advertising content are being displayed and (ii) recognizing the analyzed sequence as indicative of the viewer skipping the interleaved advertising content.

46. The article of claim 44 wherein the medium further encodes computer readable instructions that, when applied to at least one computer, instruct the at least one computer to detect automatically the viewer skipping the interleaved advertising content by detecting a “fast-forward,” “skip,” “change channel,” “mute” or “change volume,” or “switch off” command during the interleaved advertising content.

47. The article of claim 44 wherein the spatially combined advertising content is delivered from an ad server before a viewer begins viewing the television program and is stored on equipment associated with a television programming source.

48. The article of claim 44 wherein the spatially combined advertising content and the interleaved advertising content are provided by different advertisers.

49. The article of claim 44 wherein the spatially combined advertising content is selected based on (i) the viewed television program, (ii) observed viewing behavior associated with a viewer, or (iii) observed online behavior associated with a with a viewer.

50. The article of claim 44 wherein the later-viewed television program segment and the spatially combined advertising content are spatially combined by a TV programming source.

51. The article of claim 44 wherein the medium further encodes computer readable instructions that, when applied to at least one computer, instruct the at least one computer to:
interrupt, in response to an indication received from a viewer of the spatially combined advertising content, the later-viewed television program segment and presenting additional advertising content that is related to the spatially combined advertising content; and
resume thereafter the later-viewed television program segment.

52. A method comprising:
(a) automatically detecting a viewer skipping television advertising content that is temporally interleaved with segments of a television program by (i) analyzing a temporal sequence of “change channel,” “mute” or “change volume,” or “switch off” commands transmitted by the viewer during a time period in which at least a portion of the television program and interleaved advertising content are being displayed and (ii) recognizing the analyzed sequence as indicative of the viewer skipping the interleaved advertising content; and
(b) in response to the automatic detection of viewer skipping of the interleaved advertising content, automatically causing selected television advertising content to be spatially combined with at least one later-viewed television program segment so that skipping the spatially combined television advertising content also causes skipping of the corresponding later-viewed television program segment.

53. The method of claim 52 wherein the spatially combined advertising content is delivered from an ad server before a viewer begins viewing the television program and is stored on equipment associated with a television programming source.

54. The method of claim 52 wherein the spatially combined advertising content and the interleaved advertising content are provided by different advertisers.

55. The method of claim 52 wherein the spatially combined advertising content is selected based on (i) the viewed television program, (ii) observed viewing behavior associated with a viewer, or (iii) observed online behavior associated with a viewer.

56. The method of claim 52 wherein the later-viewed television program segment and the spatially combined advertising content are spatially combined by a TV programming source.

57. The method of claim 52 further comprising:
in response to an indication received from a viewer of the spatially combined advertising content, interrupting the later-viewed television program segment and presenting additional advertising content that is related to the spatially combined advertising content; and
thereafter, resuming the later-viewed television program segment.

58. A system comprising at least one computer structured and connected to:
(a) detect automatically a viewer skipping television advertising content that is temporally interleaved with segments of a television program by (i) analyzing a temporal sequence of “change channel,” “mute” or “change volume,” or “switch off” commands transmitted by the viewer during a time period in which at least a portion of the television program and interleaved advertising content are being displayed and (ii) recognizing the analyzed sequence as indicative of the viewer skipping the interleaved advertising content; and
(b) cause automatically, in response to the automatic detection of viewer skipping of the interleaved advertising content, selected television advertising content to be spatially combined with at least one later-viewed television program segment so that skipping the spatially combined television advertising content also causes skipping of the corresponding later-viewed television program segment.

59. The system of claim 58 wherein the spatially combined advertising content is delivered from an ad server before a viewer begins viewing the television program and is stored on equipment associated with a television programming source.

60. The system of claim 58 wherein the spatially combined advertising content and the interleaved advertising content are provided by different advertisers.

61. The system of claim 58 wherein the spatially combined advertising content is selected based on (i) the viewed television program, (ii) observed viewing behavior associated with a viewer, or (iii) observed online behavior associated with a viewer.

62. The system of claim 58 wherein the later-viewed television program segment and the spatially combined advertising content are spatially combined by a TV programming source.

63. The system of claim 58 further comprising at least one computer structured and connected to:
interrupt, in response to an indication received from a viewer of the spatially combined advertising content, the later-viewed television program segment and presenting additional advertising content that is related to the spatially combined advertising content; and
resume thereafter the later-viewed television program segment.

64. An article comprising a tangible medium encoding computer-readable instructions that, when applied to a least one computer, instruct the at least one computer to:
(a) detect automatically a viewer skipping television advertising content that is temporally interleaved with segments of a television program by (i) analyzing a temporal sequence of “change channel,” “mute” or “change volume,” or “switch off” commands transmitted by the viewer during a time period in which at least a portion of the television program and interleaved advertising content are being displayed and (ii) recognizing the analyzed sequence as indicative of the viewer skipping the interleaved advertising content; and
(b) cause automatically, in response to the automatic detection of viewer skipping of the interleaved advertising content, selected television advertising content to be spatially combined with at least one later-viewed television program segment so that skipping the spatially combined television advertising content also causes skipping of the corresponding later-viewed television program segment.

65. The article of claim 64 wherein the spatially combined advertising content is delivered from an ad server before a viewer begins viewing the television program and is stored on equipment associated with a television programming source.

66. The article of claim 64 wherein the spatially combined advertising content and the interleaved advertising content are provided by different advertisers.

67. The article of claim 64 wherein the spatially combined advertising content is selected based on (i) the viewed television program, (ii) observed viewing behavior associated with a viewer, or (iii) observed online behavior associated with a viewer.

68. The article of claim 64 wherein the later-viewed television program segment and the spatially combined advertising content are spatially combined by a TV programming source.

69. The article of claim 64 wherein the medium further encodes computer readable instructions that, when applied to at least one computer, instruct the at least one computer to:
interrupt, in response to an indication received from a viewer of the spatially combined advertising content, the later-viewed television program segment and presenting additional advertising content that is related to the spatially combined advertising content; and
resume thereafter the later-viewed television program segment.
